(19) United States
(12) Patent Application Publication
(10) Pub. No.: US 2023/0048223 A1
(43) Pub. Date: Feb. 16, 2023

(54) FOOD PRODUCT FORMING MACHINE

(71) Applicant: Provisur Technologies, Inc., Chicago, IL (US)

(72) Inventors: Paul Taylor, Munster, IN (US); Richard Cygan, Tinley Park, IL (US); Bruce Bauer, Mokena, IL (US)

(21) Appl. No.: 17/885,148

(22) Filed: Aug. 10, 2022

Related U.S. Application Data
(60) Provisional application No. 63/232,056, filed on Aug. 11, 2021.

(51) Int. Cl. A23P 30/10

(52) U.S. Cl. CPC A23P 30/10

(57) ABSTRACT

A food product forming machine is configured to form food products, such as food patties. A body which includes a frame, a hopper into which a supply of moldable food material is deposited, and a hydraulic tank form a one-piece weldment. At least one assembly is mounted in the frame and is configured to form a food product. A tunnel extends from the body and is configured to receive food material from the hopper. A single rotatable feed screw is mounted within the hopper and within the tunnel. A ventilation system is provided within the frame.

### CROSS-REFERENCE TO RELATED APPLICATION(S)

This application claims the priority of U.S. provisional application Ser. No. 63/232,056, filed on Aug. 11, 2021, the contents of which are incorporated herein in its entirety.

### FIELD OF THE DISCLOSURE

The present disclosure relates to a food product forming machine which may be used to form food patties.

### BACKGROUND

Food patties of various kinds, including hamburgers, molded steaks, fish cakes, chicken patties, pork patties, potato patties, and others, are frequently formed in high-volume automated molding machines.

### SUMMARY

In an embodiment, a food product forming machine is configured to form food products, such as food patties. The food product forming machine includes a body including a frame, a hopper into which a supply of moldable food material is deposited, and a hydraulic tank forming a one-piece weldment; and at least one assembly mounted in the frame which is configured to form a food product.

In an embodiment, a food product forming machine is configured to form food products, such as food patties, and includes a body including a frame and a hopper into which a supply of moldable food material is deposited, a tunnel extending from the body which is configured to receive food material from the hopper, and a single rotatable feed screw within the hopper and within the tunnel, the feed screw passing through an opening in the body.

In an embodiment, a food product forming machine is configured to form food products, such as food patties, and includes a body including a frame and a hopper into which a supply of moldable food material is deposited. The frame includes a top wall, a bottom wall, side walls extending between the top and bottom walls, and a rear wall extending between the top and bottom walls. The walls define a cavity. A hydraulic system includes a tank forming part of the cavity, a hydraulic pump coupled to the hydraulic tank, and a motor within the cavity and configured to drive the hydraulic pump. A ventilation system is provided within the cavity and includes a fan mounted on a tube extending upward from the bottom wall, and at least one exhaust tube extending upward from the bottom wall. Each tube extends a distance upwardly from the bottom wall. The fan is provided proximate to an end of the bottom wall and the at least one exhaust tube is provided proximate to an opposite end of the bottom wall.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 depicts a rear perspective view of a food product forming machine;

FIG. 2 depicts a perspective view of the food product forming machine with a door removed to show a hydraulic tank;

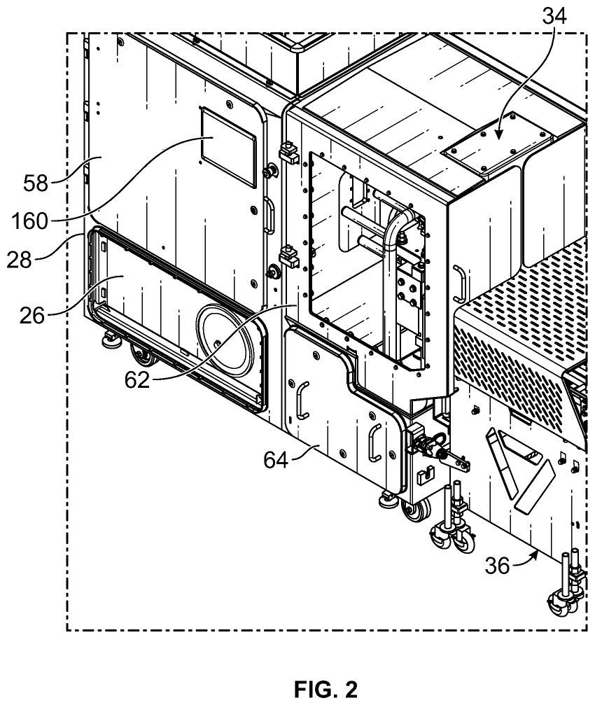

FIG. 3 depicts a cross-sectional view along line 3-3 of FIG. 1;

FIG. 4 depicts a cross-sectional view along line 4-4 of FIG. 1;

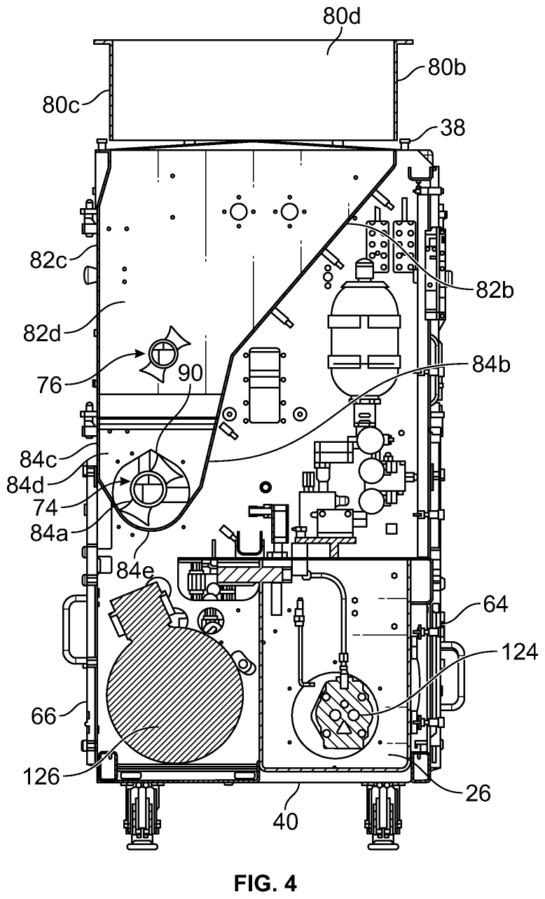

FIG. 5 is a rear end elevation view of the food product forming machine with a conveyor system removed therefrom;

FIG. 6 depicts a cross-sectional view along line 6-6 of FIG. 1;

FIG. 7 depicts a cross-sectional view along line 7-7 of FIG. 1; and

FIG. 8 depicts a cross-sectional view along line 8-8 of FIG. 1.

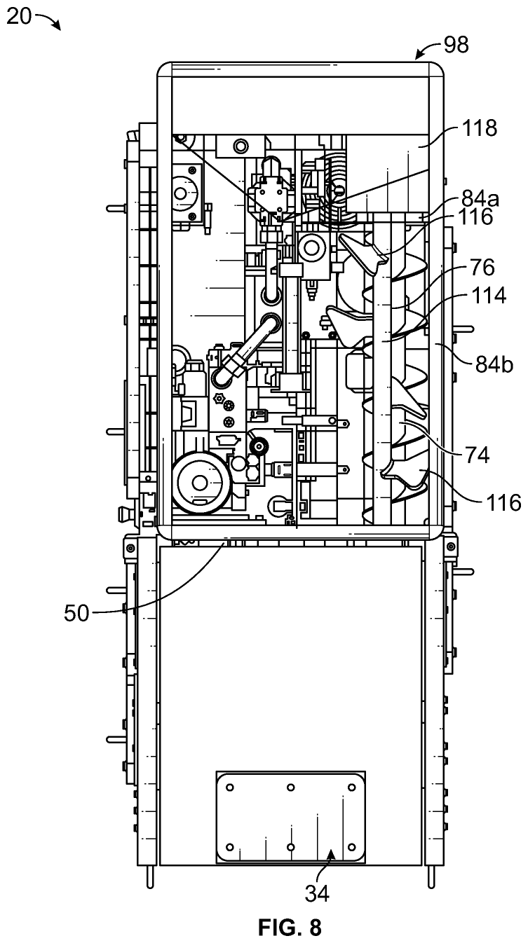

### DETAILED DESCRIPTION

While the disclosure may be susceptible to embodiment in different forms, there is shown in the drawings, and herein will be described in detail, a specific embodiment with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

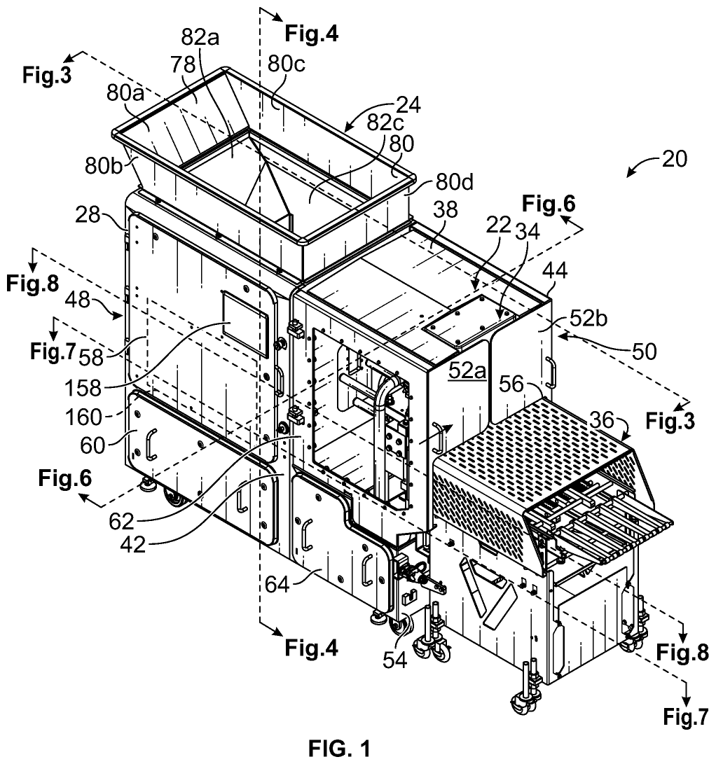

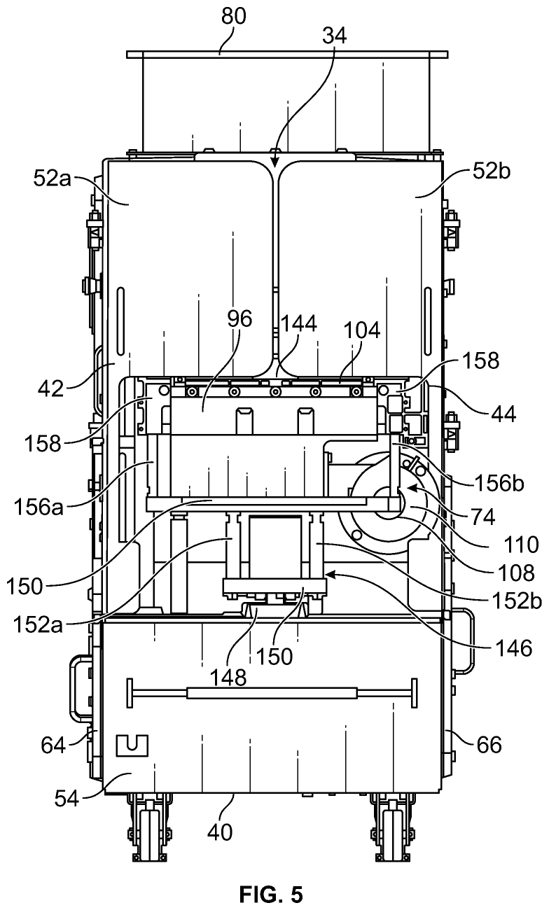

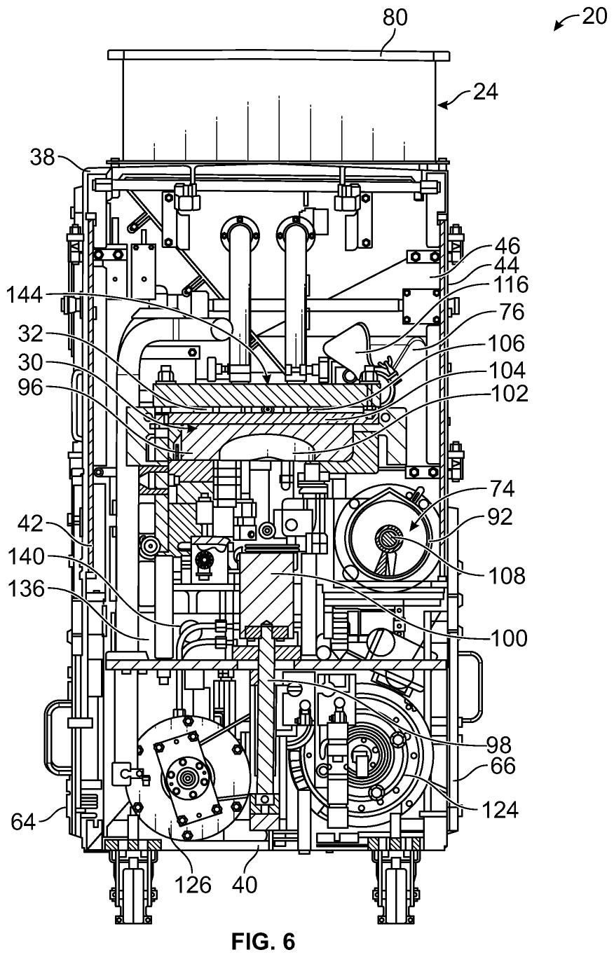

FIG. 1 illustrates a food product forming machine 20 which forms food products, such as food patties, from moldable food material, such as pork, poultry, sausage, beef or the like. Raw meat may be formed into individual food patties by the food product forming machine 20. The food product forming machine 20 includes a frame 22, a hopper 24 and a hydraulic tank 26 which form a large one-piece weldment that forms a body 28 of the food product forming machine 20. As shown in FIGS. 5 and 6, the body 28 mounts the assemblies and mechanisms used to form the food products, including a pump assembly 30 coupled to the hopper 24, a molding assembly 32 coupled to the pump assembly 30, and a knockout mechanism 34. As shown in FIG. 1, a conveyor apparatus 36 is attached to the body 28 for receiving food products from the knockout mechanism 34 and for transporting the food products for further processing, such as packaging. In one example, the knockout mechanism 34 may be as disclosed in U.S. Pat. No. 7,255,554 which is incorporated by reference to the extent not inconsistent with the description provided here.

The frame 22 is formed of one piece and has a top wall 38, a bottom wall 40, side walls 42, 44 extending between the top and bottom walls 38, 40, and a rear wall 46 extending between the top and bottom walls 38, 40. A rear end of the frame 22 is defined at 48 and a front end 50 of the frame 22 is defined at 50. The top, bottom, side and rear walls 38, 40, 42, 44, 46 are welded together to form a one-piece unit. As a result, when a customer receives the food product forming machine 20, the customer does not have to bolt the components together. Because the food product forming machine 20 is formed as one-piece, the food product forming machine 20 is cleaner, requires less assembly hours, and is less expensive to manufacture. In addition, the one-piece construction provides strength to the assembly. A pair of upper front doors 52a, 52b are used to close an upper portion of the front end 50 of the frame 22 and are engage against the front ends of the top wall 38 and the side walls 42, 44 when closed. A lower front wall 54 closes a lower portion of the front end 50 of the frame 22 and is sealed to the front ends of the bottom wall 40 and the side walls 42, 44 when closed. An opening 56 is provided between the doors 52a, 52b and the lower front wall 54, and the conveyor apparatus 36 is attached to frame 22 at the opening 56. The side wall 42 includes a plurality of doors 58, 60, 62, 64 which engage with the side wall 42 when closed, and the side wall 44 includes a plurality of doors 66 (only one of which is shown) which engage with the side wall 44 when closed. Each door 58, 60, 62, 64, 66 may be hingedly attached to the frame 22 to allow the doors 58, 60, 62, 64, 66 to be opened so that the internal components of the food product forming machine 20 can accessed. The doors 58, 60, 64, 66 are sealed against the side walls 42, 44 when closed to prevent intrusion of elements therein.

The hopper 24 receives a supply of moldable food material from overhead. A tunnel 72 extends from the body 28 and is coupled to the hopper 24. The tunnel 72 receives the food material from the hopper 24 for transport to the pump assembly 30, a cylindrical feed screw 74 within the hopper 24 for moving the food material longitudinally along the hopper 24, and an agitator 76 within the hopper 24 for directing the food material to a front end of the feed screw 74.

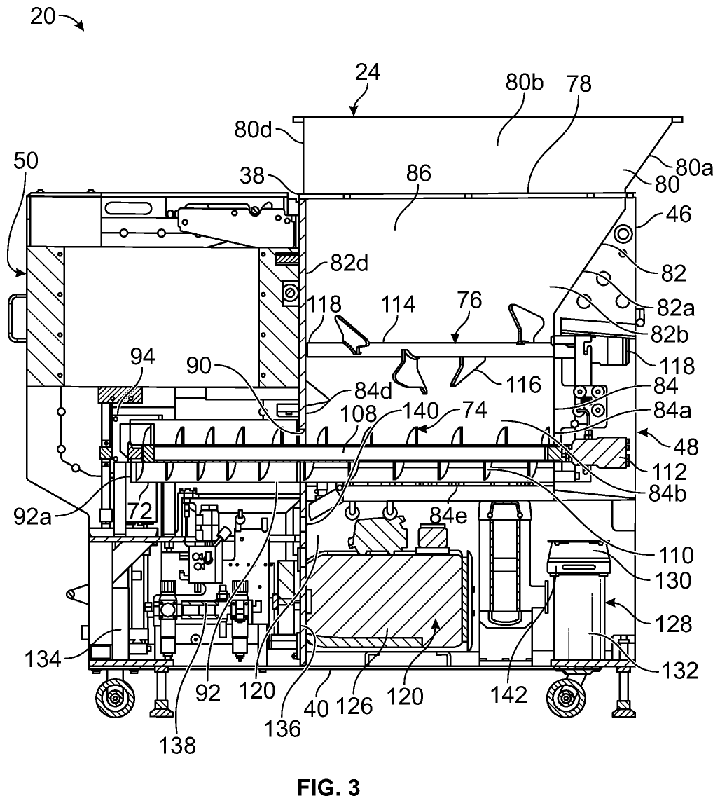

The hopper 24 has an open upper end 78 and extends from the top wall 38. As shown in FIG. 3, the hopper 24 has a hopper extension or upper section 80 which extends upward from the top wall 38, a middle section 82 which extends downward from the top wall 38 and the upper section 80, and a lower section 84 which extends downward from the middle section 82. As shown in FIG. 1, the upper section 80 has a rear wall 80a which extends at an angle relative to vertical and relative to the vertical rear wall 46, a first vertical side wall 80b which extends forward from the rear wall 80a and is proximate to the side wall 42, a second vertical side wall 80c which extends forward from the rear wall 80a and is proximate to the side wall 44, and a front vertical wall 80d which extends between front ends of the side walls 80b, 80c. The middle section 82 has a rear wall 82a which extends downward from the rear wall 80a at an angle relative thereto and at an angle relative to vertical, a first side wall 82b which extends down from the first side wall 80b at an angle relative to vertical, a second vertical side wall 82c which extends down from the second side wall 80c, and a front vertical wall 82d which extends down from the front wall 80d. The lower section 84 has a vertical rear wall 84a which extends down from the rear wall 82a, a first side wall 84b which extends down from the first side wall 82b and is at an angle from vertical, a second side wall 84c which extends down from the second side wall 82c and is generally vertical, a vertical front wall 84d which extends down from the front wall 82d, and a bottom wall 84e which closes the lower ends of the walls 84a, 84b, 84c, 84d and is curved. The hopper 24 defines a cavity 86 which is in communication with the open upper end 78. The front wall 84d has an opening 90 therethrough which aligns with the lower section 84 of the hopper 24 and through which the cylindrical feed screw 72 passes. Walls 84b, 84c are generally parallel to each other. In some embodiments, the hopper extension or upper section 80 is not included and the open upper end 78 is in the top wall 38.

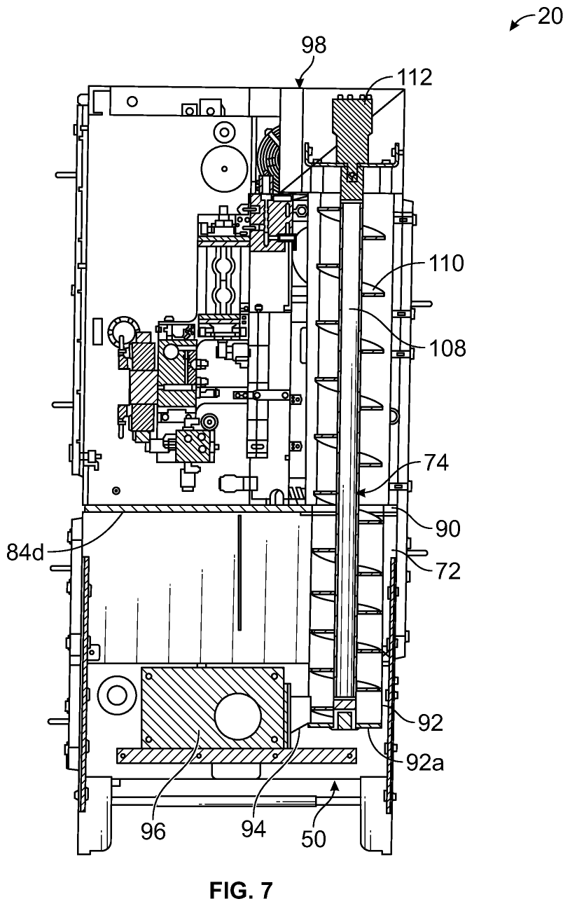

The tunnel 72 is coupled to and extends forward from the front wall 84d of the lower section 84 and is in communication with the lower section 84 through the opening 90. As shown in FIG. 7, the tunnel 72 has a first section 92 which extends from the front wall 84d, and a second section 94 which is perpendicular to the first section 92. The first section 92 has a passageway extending therethrough which conforms to the shape of the opening 90. The second section 94 is coupled to the pump assembly 30. The second section 94 has a passageway extending therethrough which may be rectangular.

The pump assembly 30 includes a pump box 96 and, a hydraulic cylinder 98 having a plunger 100 which is movable relative to the cylinder 98 and within the pump box 96. The pump box includes a manifold 102 therein in which the food material is received from the second section 94 of the tunnel 72 which is coupled thereto. The plunger of the hydraulic cylinder 98 is in communication with the manifold 102. The plunger 100 of the hydraulic cylinder 98 pushes the food material received in the manifold 102 upwardly into the molding assembly 32 above the pump box 96. As is known in the art, a mold plate 104 of the molding assembly 32 is movable once mold cavities in the mold plate 104 are filled to form the food products. The molding assembly 32 may further include a breather plate 106 above the mold plate 104, as is known in the art. In an embodiment, the mold plate 104 reciprocates relative to the pump box 96. The knock-out mechanism 34 knocks the formed food products out of the mold cavities and the food products fall onto the conveyor apparatus 36. A linear encoder may be provided to relay the position of the plunger 100 to a control system.

The cylindrical feed screw 74 is mounted in the lower section 84 of the hopper 24 and in the first section 92 of the tunnel 72. The feed screw 74 has a shaft 108 around which a single helical fighting 110 is provided. The fighting 110 has a plurality of turns that circumnavigate the shaft 108. Between adjacent turns, a pitch of the fighting 110 is defined as is known in the art. The curved lower wall 84e of the lower section 84 of the hopper 24, the opening 90 and the passageway in the first section 92 of the tunnel 72 generally conform in shape to the feed screw 74. The distance between the side walls 84b, 84c of the lower section 84 is slightly greater than the diameter of the cylindrical feed screw 74 defined by the fighting 110. The side walls 84b, 84c form a channel which ensure engagement of the food product with the feed screw 74. A rear end of the shaft 108 is rotatably attached to the rear wall 84a of the hopper 24, and a front end of the shaft 108 is rotatably attached to a front wall 92a of the first section 92 of the tunnel 72. The pitch of the fighting 110 of the feed screw 74 is variable along the length of the shaft 108. In an embodiment, the feed screw 74 has three different pitches along its length. A first portion of the fighting 110 of the feed screw 74 that extends from the rear wall 84a has a first larger pitch, for example a 9″ pitch, a second portion of the fighting 110 of the feed screw 74 that extends from the first portion has a second, smaller pitch, for example a 5″ pitch, and a third portion of the fighting 110 of the feed screw 74 that extends from the second portion to the front wall 92a has a third, smaller pitch, for example a 4″ pitch. The third portion is within the first section 92 of the tunnel 72. The feed screw 74 is rotatably driven by a hydraulic motor 112 at an end thereof which is keyed to the shaft 108.

To remove the feed screw 74 for cleaning, the tunnel 72 is uncoupled from the hopper 24 and the pump box 96 and is pulled off of the feed screw 74. The feed screw 74 is then removed from the hopper 24 by pulling it outwardly through the opening 90. The provision of a single feed screw 74 results in a cost reduction to manufacture, reduction of weight, and reduction of time to clean and assemble the food product forming machine 20.

The agitator 76 is mounted within the lower section 84 of the hopper 24 directly above the feed screw 74. The agitator 76 has a shaft 114 to which a plurality of space apart paddles 116 are attached. The paddles 116 extend outward from the shaft 114 and are angled relative to the shaft 114. A rear end of the shaft 114 is rotatably attached to the rear wall 84a of the hopper 24, and a front end of the shaft 114 is rotatably attached to the front wall 84d of the hopper 24. The agitator 76 is attached to the front wall 84d by a bushing 118 that is held in place with a single clamp. In order to remove the agitator 76, the clamp is released, for example by being unscrewed, and the bushing 118 is pulled outward from the front wall 84d. The agitator 76 is then pulled upward through the hopper 24 and through the open upper end 78. Thereafter, the agitator 76 can be easily cleaned. The agitator 76 is rotatably driven by a hydraulic motor 118 at the rear end thereof which is keyed to the shaft 114. The distance between the side walls 84b, 84c is slightly greater than the diameter of the agitator 76 defined between ends of opposite paddles 116. The walls 84b, 84c form a channel which ensure engagement of the food product with the agitator 76.

Food material is deposited through the open upper end 78 of the hopper 24 and passes through the upper section 80 of the hopper 24 (if the upper section 80 is provided), and into the middle section 82 of the hopper 24. The food material moves into the lower section 84 and comes into contact with the rotating agitator 76 which forces the food material toward the rear wall 84a and the rear end of the feed screw 74 that has the largest pitch. The food material passes further into the lower section 84 to engage with the rear end of the feed screw 74. Some food material will also pass by the agitator 76. Since the feed screw 74 has a larger pitch at the rear end, a large amount of food material will engage with the rear end of the feed screw 74. Upon rotation of the feed screw 74, the food material translates along the length of the shaft 108 along the fighting 110. When the food material travels along the front portion of the shaft 108 with the smallest pitch, the food material can only move forwardly toward the second section 94 of the tunnel 72 since the food material becomes trapped within the first portion 92 of the tunnel 72. This makes the transfer of the food material from the hopper 24 to the pump assembly 30 more efficient. The feed screw 74 and tunnel 72 force the food material to flow in one direction. It has been found that up to 80% efficiency of food transfer is achieved using the single feed screw 74.

The hydraulic motors 112, 118 are driven by a hydraulic system 120 mounted within a lower cavity 122 in the frame 22. The hydraulic system 120 includes the hydraulic tank 26, a hydraulic pump 124, a motor 126 for driving the hydraulic pump 124, and a plurality of hydraulic lines connecting the components of the hydraulic system 120 together and to the hydraulic motors 112, 118. The hydraulic pump 124 may be mounted within the hydraulic tank 26 in order to minimize noise. The motor 126 may be an AC induction motor. The motor 126 may be resting on the upper surface of the bottom wall 40.

Since the motor 126 is mounted within the lower cavity 122, a ventilation system 128 is provided in the frame 22 to remove heat generated by the motor 126. As shown in FIG. 3, the ventilation system 128 includes a fan 130 mounted on a tube 132 that extends upward from the bottom wall 40, and at least one exhaust tube 134 that extends upward from the bottom wall 40. The tube 132 is open at its lower end and has the fan 130 closing its upper end, and the exhaust tube(s) 134 is open at its upper and lower ends. Each tube 132, 134 extends a distance upwardly from the bottom wall 40, for example 12 inches. The fan 130 is provided at the rear end of the bottom wall 40 proximate to the rear wall 46, and the exhaust tube(s) 134 is provided at the front end of the bottom wall 40. When the food product forming machine 20 is sprayed by cleaning fluids, any cleaning fluids that are splashed onto the ground and then up onto the bottom wall 40 will not enter into the lower cavity 122. The cleaning fluids may enter into the tubes 130, 132, however, because the tubes 130, 132 have a height, a labyrinth is formed which prevents the travel of the cleaning fluids all of the way to the open top ends of the tubes 130, 132. Therefore, the cleaning fluids cannot enter into the cavity 122. This provides a sanitary environment within the cavity 122, and does not expose the components in the cavity 122 to the harsh environment.

A dividing wall 136 may be provided to divide the cavity 122 into a front compartment in which the hydraulic tank 26 and most of the hydraulic system 120 is provided, and a rear compartment which houses a pneumatic regulator 138. The dividing wall 136 may be formed as a lower portion of the front wall 84d of the hopper 24. The dividing wall 136 has a plurality of apertures 140 therethrough to allow for air to flow therethrough from the fan 130 drawing air into the cavity 122 through the tube 132 to the exhaust tube(s) 134.

A tray 142 having a filter material may be provided below the fan 130. Upon opening the door 66, the tray 142 may be pulled out and the filter material replaced.

A cover 144 is provided which covers the mold plate 104. As shown in FIG. 5, the knockout mechanism 34 is mounted on top of the cover 144. A lift assembly 146 is provided to raise the cover 144 and the knockout mechanism 34 so that the mold plate 104 can be serviced for cleaning. The lift assembly 146 includes a hydraulic cylinder 148 which is mounted on the bottom wall 40 in the front compartment, a lower horizontal plate 150 at the upper end of the hydraulic cylinder 148, a pair of spaced apart arms 152a, 152b extending from opposite ends of the plate 150 and which are coupled to an underside of an upper horizontal plate 154, and a pair of spaced apart arms 156a, 156b extending from opposite ends of the plate 154 and which are coupled to an underside of the cover 144. The arms 152a, 152b pass through supports 158 extending from opposite sides of the pump box 96. Upon actuation of the hydraulic cylinder 148, the cover 144 and knockout mechanism 34 are raised, such that the knockout mechanism 34 moves upward and away from the mold plate 104 and the pump box 96. The mold plate 104 can be removed and cleaned.

Electrical enclosures 160, which may provide high voltage and low voltage, are mounted on an interior of the door 58 to make access easy for the operator and power the components of the food product forming machine 20. To access the electrical enclosures 160, the door 58 is opened. The electrical enclosures 160 are located at eye/waist level. A Human Machine Interface (HMI) 162 is also mounted on the door 58.

With prior art food product forming machines, the components had to be bolted together which was time consuming. With the present food product forming machine, the large one-piece weldment that forms the body 28 of the food product forming machine 20 avoids this.

In addition, a customer can order the food product forming machine 20 in more than one size. Most of the components of the food product forming machine 20 can be used for all sizes. Different sizes of the food product forming machine 20 have different widths of the pump assembly 30, the mold plate 104, the knockout mechanism 34, the conveyor apparatus 36 and the lift assembly 146. Therefore, the food product forming machine 20 can be provided in different sizes by only changing these components which are downstream of the tunnel 72. This provides a significant cost savings for the manufacturer.

Many modifications and other embodiments of the disclosure set forth herein will come to mind to one skilled in the art to which these disclosed embodiments pertain having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

What is claimed is:

1. A food product forming machine comprising:
a body including a frame, a hopper into which a supply of moldable food material is deposited, and a hydraulic tank forming a one-piece weldment; and
at least one assembly mounted in the frame which is configured to form a food product.

2. The food product forming machine of claim 1, wherein the at least one assembly includes a pump assembly coupled to the hopper, and a molding assembly coupled to the pump assembly.

3. The food product forming machine of claim 1, wherein the hopper defines an open ended cavity, and further comprising a tunnel extending from the body which is configured to receive food material from the hopper, and a rotatable feed screw within the hopper and within the tunnel, the feed screw passing through an opening in the body.

4. The food product forming machine of claim 3, wherein the feed screw has a variable pitch from a front end thereof to a rear end of the feed screw.

5. The food product forming machine of claim 3, wherein the tunnel, a portion of the hopper and the opening define a passageway which generally conforms in shape to the feed screw.

6. The food product forming machine of claim 5, wherein the feed screw has a variable pitch from a front end thereof to a rear end of the feed screw, and wherein the pitch at the front end is greater than the pitch of the feed screw at the rear end thereof, the front end of the feed screw being positioned within the hopper and the rear end of the feed screw being positioned within the tunnel.

7. The food product forming machine of claim 3, wherein the tunnel is decouplable from the body to expose the opening between the hopper and the tunnel.

8. The food product forming machine of claim 3, wherein the at least one assembly includes a pump assembly coupled to the tunnel, and a molding assembly coupled to the pump assembly.

9. The food product forming machine of claim 3, wherein the feed screw is driven by a motor, the motor being driven by a hydraulic system, wherein the hydraulic tank forms part of the hydraulic system.

10. The food product forming machine of claim 3, further comprising a rotatable agitator within the hopper which is configured to direct food material to a front end of the feed screw, the agitator being positioned above the feed screw.

11. The food product forming machine of claim 10, wherein the feed screw is driven by a motor which is driven by a hydraulic system, the agitator is driven by a motor which is driven by the hydraulic system, wherein the hydraulic tank forms part of the hydraulic system.

12. The food product forming machine of claim 10, wherein a portion of the hopper in which the agitator is mounted generally conforms in shape to the agitator.

13. The food product forming machine of claim 12, wherein the tunnel, a portion of the hopper and the opening define a passageway which generally conforms in shape to the feed screw.

14. The food product forming machine of claim 10, wherein the agitator is coupled to the hopper by a bushing and is decouplable from the hopper.

15. The food product forming machine of claim 1,
wherein the frame includes a top wall, a bottom wall, side walls extending between the top and bottom walls, and a rear wall extending between the top and bottom walls, the walls defining a cavity; and
further comprising:
a hydraulic pump coupled to the hydraulic tank;
a motor within the cavity and configured to drive the hydraulic pump; and
a ventilation system within the cavity comprising a fan mounted on a tube extending upward from the bottom wall, and at least one exhaust tube extending upward from the bottom wall, wherein each tube extends a distance upwardly from the bottom wall, and wherein the fan is provided proximate to an end of the bottom wall and the at least one exhaust tube is provided proximate to an opposite end of the bottom wall.

16. The food product forming machine of claim 15, wherein the tubes extend upward 12 inches from the bottom wall.

17. A food product forming machine comprising:
a body including a frame and a hopper into which a supply of moldable food material is deposited;
a tunnel extending from the body which is configured to receive food material from the hopper; and
a single rotatable feed screw within the hopper and within the tunnel, the feed screw passing through an opening in the body.

18. The food product forming machine of claim 17, wherein the feed screw has a variable pitch from a front end thereof to a rear end thereof.

19. The food product forming machine of claim 17, wherein the tunnel, a portion of the hopper and the opening define a passageway which generally conforms in shape to the feed screw.

20. The food product forming machine of claim 19, wherein the feed screw has a variable pitch from the front end thereof to a rear end thereof, and wherein the pitch at the front end is greater than the pitch of the feed screw at the rear end thereof, the front end of the feed screw being positioned within the hopper and the rear end of the feed screw being positioned within the tunnel.

21. The food product forming machine of claim 17, wherein the tunnel is decouplable from the body to expose the opening between the hopper and the tunnel.

22. The food product forming machine of claim 17, further comprising a rotatable agitator within the hopper which is configured to direct food material to a front end of the feed screw, the agitator being positioned above the feed screw.

23. The food product forming machine of claim 22, wherein a portion of the hopper in which the agitator is mounted generally conforms in shape to the agitator.

24. The food product forming machine of claim 23, wherein the tunnel, a portion of the hopper and the opening define a passageway which generally conforms in shape to the feed screw.

25. The food product forming machine of claim 22, wherein the agitator is coupled to the hopper by a bushing and is decouplable from the hopper.

26. A food product forming machine comprising:
a body including a frame and a hopper into which a supply of moldable food material is deposited, the frame including a top wall, a bottom wall, side walls extending between the top and bottom walls, and a rear wall extending between the top and bottom walls, the walls defining a cavity;
a hydraulic system including a tank forming part of the cavity, a hydraulic pump coupled to the hydraulic tank, and a motor within the cavity and configured to drive the hydraulic pump; and
a ventilation system within the cavity comprising a fan mounted on a tube extending upward from the bottom wall, and at least one exhaust tube extending upward from the bottom wall, wherein each tube extends a distance upwardly from the bottom wall, and wherein the fan is provided proximate to an end of the bottom wall and the at least one exhaust tube is provided proximate to an opposite end of the bottom wall.

27. The food product forming machine of claim 26, wherein the tubes extend upward from the bottom wall 12 inches.

28. The food product forming machine of claim 26, further comprising a rotatable feed screw mounted within the hopper; and a motor configured to drive the feed screw which is coupled to the hydraulic system.
